(19) United States
(12) Patent Application Publication
(10) Pub. No.: US 2026/0051687 A1
(43) Pub. Date: Feb. 19, 2026

(54) CONNECTOR

(71) Applicant: Yazaki Corporation, Tokyo (JP)

(72) Inventors: Hideki SAITO, Shizuoka (JP); Takuya Hasegawa, Shizuoka (JP)

(73) Assignee: Yazaki Corporation, Tokyo (JP)

(21) Appl. No.: 19/293,428

(22) Filed: Aug. 7, 2025

(30) Foreign Application Priority Data
Aug. 13, 2024 (JP) 2024-134946

(51) Int. Cl. H01R 13/426; H01R 13/436

(52) U.S. Cl. CPC H01R 13/426; H01R 13/4362

(57) ABSTRACT

A connector includes a housing and a retainer, and the retainer includes a base portion and a side wall portion. A length of the side wall portion in a first direction is longer than a length of the base portion in the first direction. Further, the side wall portion includes a locking portion that is locked to the housing, when the retainer is located at a final locking position, and a backlash filling portion that abuts on the housing, when the retainer is located at the final locking position. The locking portion is formed such that at least a part of the locking portion is located at a part of the side wall portion projecting from the base portion in the first direction. The backlash filling portion is formed at a position spaced apart from the locking portion in the first direction.

### CROSS-REFERENCE TO RELATED APPLICATIONS

The present application is based on, and claims priority from the Japanese Patent Application No. 2024-134946, filed on Aug. 13, 2024, the entire contents of which are incorporated herein by reference.

### TECHNICAL FIELD

The disclosure relates to a connector.

### BACKGROUND

As a conventional connector of this type, a connector disclosed in JP 2013-055018 A is proposed. JP 2013-055018 A discloses a connector including a housing and a retainer which is mounted to the housing. JP 2013-055018 A discloses that the retainer is mounted to the housing, in a state where the retainer can slide between a temporary locking position and a final locking position. A first locking projection and a second locking projection are formed on the retainer.

By locking the first locking projection to a final locking portion formed in the housing, when the retainer is moved to the final locking position, the retainer is held by the housing in a final locking state. Further, by abutting the second locking projection on an insertion force increasing portion formed in the housing, when the retainer is moved to the final locking position, it is possible to suppress backlash of the retainer held by the housing in the final locking state.

In this way, JP 2013-055018 A discloses that the retainer includes the first locking projection as a locking portion, and the second locking projection as a backlash filling portion. Due to the above, when the retainer is finally locked to the housing, the retainer is held by the housing in a state where the backlash is suppressed.

### SUMMARY OF THE INVENTION

In this way, in the connector having the retainer which is held by the housing, in a state where backlash is suppressed, it is preferable to more reliably ensure the holding force between the retainer and the housing in the final locking state.

An object of the disclosure is to provide a connector which can more reliably ensure the holding force between a retainer and a housing, while suppressing backlash of the retainer in a final locking state.

A connector according to an aspect of the present disclosure includes: a housing formed such that a cavity in which a terminal fitting is accommodated extends in a first direction; and a retainer that is inserted into the housing from one side in a second direction crossing the first direction, and that is mounted to the housing, in a state where the retainer can slide between a temporary locking position at which the retainer is temporarily locked to the housing, and a final locking position at which the retainer is finally locked to the housing, in which the retainer includes: a base portion that allows the terminal fitting to be inserted into and removed from the cavity, when the retainer is located at the temporary locking position, and that is engaged with the terminal fitting accommodated in the cavity and regulates separation of the terminal fitting from the cavity, when the retainer is located at the final locking position; and a side wall portion connected consecutively to an end of the base portion in a third direction crossing the first direction and the second direction, a length of the side wall portion in the first direction is longer than a length of the base portion in the first direction, the side wall portion includes: a locking portion that faces the housing in the third direction and that is locked to the housing, when the retainer is located at the final locking position; and a backlash filling portion that projects outward in the third direction and abuts on the housing, when the retainer is located at the final locking position, the locking portion is formed such that at least a part of the locking portion is located at a part of the side wall portion projecting from the base portion in the first direction, and when the retainer is viewed in the third direction, the backlash filling portion is formed at a position spaced apart from the locking portion in the first direction.

The present disclosure makes it possible to provide a connector which can more reliably ensure the holding force between a retainer and a housing, while suppressing backlash of the retainer in a final locking state.

### BRIEF DESCRIPTION OF DRAWINGS

FIG. 1 is an exploded perspective view of an example of a connector as viewed from above.

FIG. 2 is a perspective view of an example of a housing as viewed from below.

FIG. 3 is a back view illustrating an example of the housing.

FIG. 4 is a side view illustrating an example of the housing.

FIG. 5 is a cross-sectional view of the housing which is taken along line A-A in FIG. 4.

FIG. 6 is a perspective view of an example of a retainer as viewed from above.

FIG. 7 is a front view illustrating an example of the retainer.

FIG. 8 is a side view illustrating an example of the retainer.

FIG. 9 is a back view illustrating an example of the retainer.

FIG. 10 is a diagram illustrating a state where an example of the retainer is temporarily locked to an example of the housing, and is a cross-sectional view corresponding to FIG. 6.

FIG. 11 is an enlarged view of the main part of FIG. 10.

FIG. 12 is a diagram illustrating a state where an example of the retainer is finally locked to an example of the housing, and is a cross-sectional view corresponding to FIG. 6.

FIG. 13 is an enlarged view of the main part of FIG. 12.

### DETAILED DESCRIPTION OF THE INVENTION

Various embodiments will be described hereinafter with reference to the accompanying drawings.

Hereafter, a connector according to the present embodiment will be described in detail with reference to the drawings. Note that the dimensional ratios in the drawings are exaggerated for illustrative purposes and may differ from the actual ratios.

Further, in the following embodiment, a direction in which a terminal fitting is inserted into a housing is defined and explained as an X direction (first direction: front and rear direction). A direction in which a retainer is inserted into the housing (sliding direction of retainer relative to housing) is defined and explained as a Z direction (second direction: up and down direction). Further, a direction crossing the X direction (first direction: front and rear direction) and the Z direction (second direction: up and down direction) is defined and explained as a Y direction (third direction: width direction).

Further, an up and down direction of each member is defined and explained, in a state where the retainer is inserted into the housing by moving the retainer of a connector relative to the housing from bottom to top. When the connector is fitted to a mating connector, the side facing the mating connector is defined and explained as the front side in the front and rear direction.

A connector 1 according to the present embodiment can be used as a connector for an automobile, and can be used for electrically connecting between electrical components such as between a power source and a device, or between a device and a device, for example. The connector 1 is electrically connected to one electrical component of the electrical components, and fitted to a mating connector (not illustrated) electrically connected to the other electrical component of the electrical components. In the present embodiment, it is assumed that the mating connector is a male connector, and the connector 1 is a female connector. One or more wires (not illustrated) electrically connected to the electrical components are individually connected to the connector 1 through terminal fittings 6.

Each terminal fitting 6 is formed in an approximately rod-like shape using a conductive material, and is coupled to a terminal of each wire. Each terminal fitting 6 includes a connected portion 61, a coupled portion 62, and an intermediate portion 63.

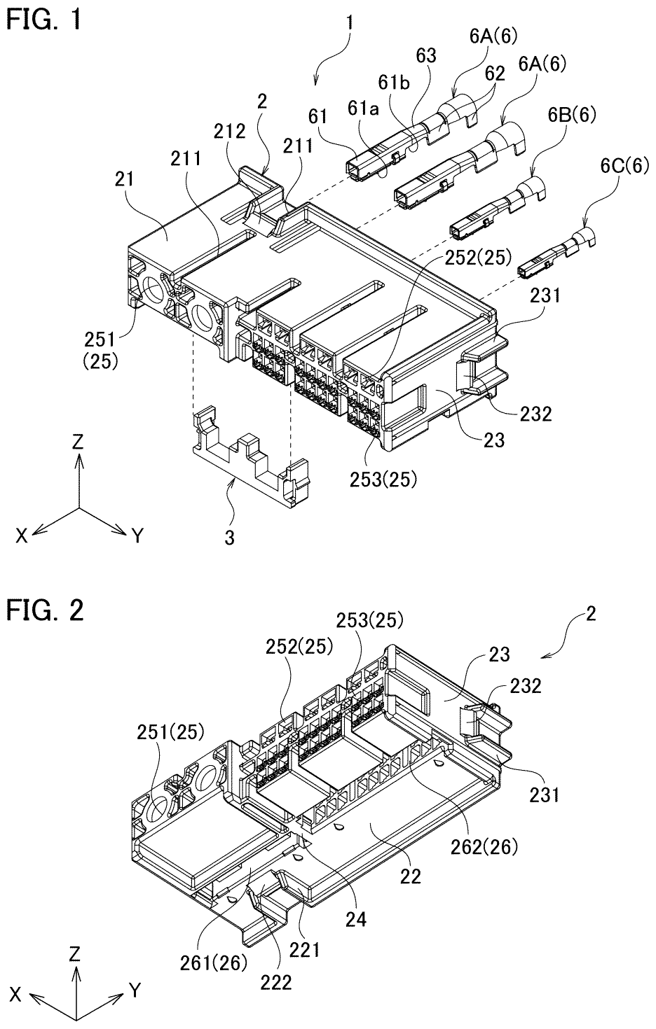

The connected portion 61 is a portion to which a mating terminal of the mating connector is connected from the outside. The shape of the connected portion 61 may be an approximately box-like shape, such that the connected portion 61 can be inserted into a tab-shaped mating connection portion disposed at the mating terminal. At this time, an elastic piece having a contact part contacting the mating connection portion is disposed inside the connected portion 61. Further, a locked portion 61a (see FIG. 1) is formed on an outer surface of the connected portion 61, and the locked portion 61a can be locked to a locking projection (not illustrated) of a lance formed in a housing 2, which will be described later. An engagement recess 61b engaged with a terminal engaging portion 41b of a retainer 3 described later is formed at a lower end of the intermediate portion 63.

Further, a wire is coupled to the coupled portion 62 of each terminal fitting 6. The coupled portion 62 may include a conductor crimper constituted by a pair of press-fastening pieces, and a sheath fixing portion constituted by a pair of press-fastening pieces, for example. The conductor crimper is crimped to a conductor of the wire by press-fastening the pair of press-fastening pieces. Each terminal fitting 6 is electrically connected to the wire by crimping the conductor crimper to the conductor of the wire. Meanwhile, the sheath fixing portion is fixed to a sheath of the wire by press-fastening the pair of press-fastening pieces. Each terminal fitting 6 is fixed to the wire by fixing the sheath fixing portion to the sheath of the wire.

The intermediate portion 63 is interposed between the connected portion 61 and the coupled portion 62, and is used to integrate the connected portion 61 and the coupled portion 62.

In this way, in the present embodiment, the connector 1 includes the terminal fittings 6. Further, the connector 1 includes the housing 2 with cavities 25 in which the terminal fittings 6 are accommodated, and the retainer 3 inserted into the housing 2.

The housing 2 is formed of an insulating material such as synthetic resin, and is a housing member fitted to a mating housing of the mating connector, for example. As in the present embodiment, the housing when the connector is a female connector may be referred to as a female housing.

In the present embodiment, the housing 2 includes a top wall 21, a bottom wall 22 facing the top wall 21 in a Z direction (second direction: up and down direction), and a pair of side walls 23 connected consecutively to ends of the top wall 21 and the bottom wall 22 in a Y direction (third direction: width direction). The housing 2 has an approximately rectangular parallelepiped shape, and is formed to have an approximately elongated rectangular shape in the Y direction (third direction: width direction) in a front view (when housing 2 is viewed along X direction).

In the present embodiment, the top wall 21 has a guide projection 211 inserted into a guide groove formed in the mating connector, and a lock piece 212 engaged with a lock formed at the mating connector, when the connector 1 is fitted to the mating connector. Further, the bottom wall 22 also has a guide projection 221 inserted into the guide groove formed in the mating connector, and a lock piece 222 engaged with the lock formed at the mating connector, when the connector 1 is fitted to the mating connector. Still further, the side wall 23 also has a guide projection 231 inserted into the guide groove formed in the mating connector, and a lock piece 232 engaged with the lock formed at the mating connector, when the connector 1 is fitted to the mating connector.

A plurality of cavities 25 passing through in an X direction (first direction: front and rear direction) are formed in the housing 2.

In the present embodiment, three types of cavities 25 are formed in the housing 2. Specifically, the three types of cavities 25, that are, a first cavity 251, a second cavity 252, and a third cavity 253, are formed in the housing 2. In the present embodiment, the first cavity 251 is a cavity 25 in which the cross-sectional area when cut in a YZ plane is relatively large. The second cavity 252 is a cavity 25 in which the cross-sectional area when cut in the YZ plane is smaller than the cross-sectional area of the first cavity 251. Further, the third cavity 253 is a cavity 25 in which the cross-sectional area when cut in the YZ plane is smaller than the cross-sectional area of the second cavity 252.

Three types of terminal fittings 6 having different sizes are accommodated in the three types of cavities 25, individually.

Specifically, a first terminal fitting 6A having the largest size is inserted into the first cavity 251 from the rear side in the X direction (first direction: front and rear direction), and the first terminal fitting 6A is accommodated in the first cavity 251. The first terminal fitting 6A can be used as a terminal for a power source, for example.

Further, a second terminal fitting 6B having an intermediate size is inserted into the second cavity 252 from the rear side in the X direction (first direction: front and rear direction), and the second terminal fitting 6B is accommodated in the second cavity 252. The second terminal fitting 6B can be used as a grounding terminal, for example.

A third terminal fitting 6C having the smallest size is inserted into the third cavity 253 from the rear side in the X direction (first direction: front and rear direction), and the third terminal fitting 6C is accommodated in the third cavity 253. The third terminal fitting 6C can be used as a signal terminal, for example.

FIG. 1 illustrates an example in which, as the three types of terminal fittings 6, terminal fittings (first terminal fitting 6A, second terminal fitting 6B, and third terminal fitting 6C) having different sizes but having approximately the same shape are used. However, alternative terminal fittings having different sizes and shapes can be used.

Further, in the present embodiment, two first cavities 251 are formed on one side of the Y direction (third direction: width direction) of the housing 2, such that the first cavities 251 are aligned in the Y direction (third direction: width direction). Still further, a plurality of second cavities 252 and a plurality of third cavities 253 are formed on the other side of the Y direction (third direction: width direction) of the housing 2. Specifically, on the other side of the Y direction (third direction: width direction) of the housing 2, three rows are formed in the Z direction (second direction: up and down direction), and in each row, a plurality of cavities 25 are arranged side by side in the Y direction (third direction: width direction). The cavities 25 in the uppermost row are second cavities 252, and six second cavities 252 are formed, such that the second cavities 252 are aligned in the Y direction (third direction: width direction). Further, the cavities 25 in the middle row and the cavities 25 in the lowermost row are third cavities 253, and in each row, ten third cavities 253 are formed such that the third cavities 253 are aligned in the Y direction (third direction: width direction).

Further, in the present embodiment, the housing 2 has a partition wall 24, and the partition wall 24 separates a region where the first cavities 251 are formed, from a region where the second cavities 252 and the third cavities 253 are formed.

Further, in the housing 2, a retainer insertion space 26 in which the retainer can be inserted, is formed such that the retainer insertion space 26 opens on one side (lower side) in the Z direction (second direction: up and down direction). The retainer can be held by the housing 2 by inserting the retainer through the opening.

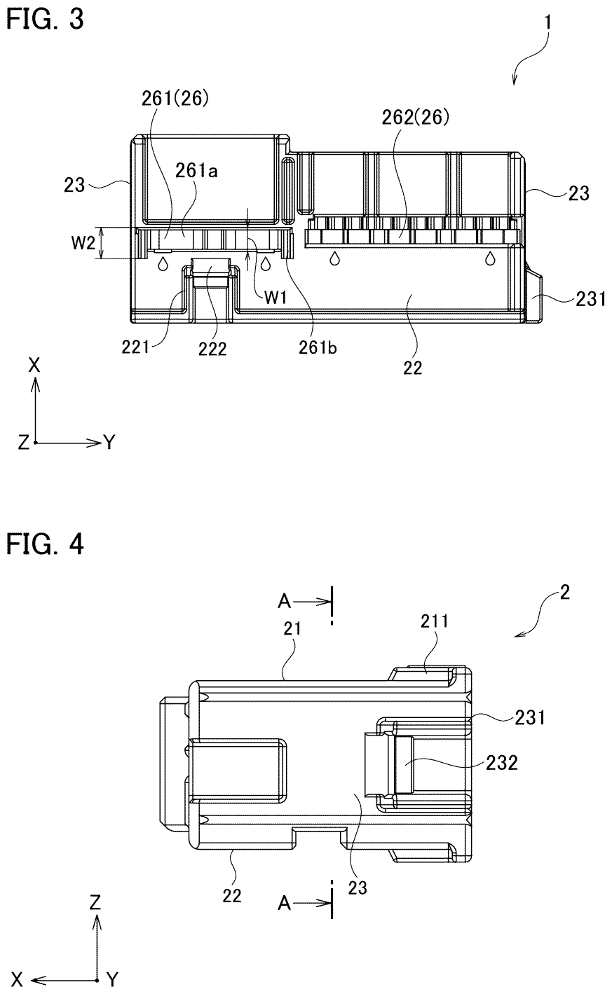

In the present embodiment, as illustrated in FIGS. 2 and 3, the retainer insertion space 26 includes a first retainer insertion space 261 which is formed to cross the two first cavities 251 in the Y direction (third direction: width direction) at a center part in the X direction (first direction: front and rear direction). Further, the retainer insertion space 26 includes a second retainer insertion space 262 which is formed to cross the plurality of second cavities 252 and third cavities 253 in the Y direction (third direction: width direction) at the center part in the X direction (first direction: front and rear direction).

Then, by inserting the retainer 3 into the first retainer insertion space 261 and finally locking the retainer 3, the first terminal fitting 6A accommodated in the first cavity 251 is doubly locked. That is, the first terminal fitting 6A accommodated in the first cavity 251 is engaged with the terminal engaging portion 41b formed at the retainer 3, while being locked to a lance formed in the first cavity 251. In this way, it is possible to enhance the holding force of the first terminal fitting 6A by the housing 2, and the first terminal fitting 6A accommodated in the first cavity 251 can be more reliably prevented from falling off from the housing 2.

In the present embodiment, as the connector 1, a connector in which the retainer is not inserted into the second retainer insertion space 262 is exemplified. However, it is also possible to use a connector in which the retainer is inserted into the second retainer insertion space 262 as the connector 1.

Further, in the present embodiment, as illustrated in FIG. 3, the first retainer insertion space 261 has an inner insertion space 261a having an approximately rectangular shape elongated in the Y direction (third direction: width direction) in plan view. Further, the first retainer insertion space 261 has a pair of outer insertion spaces 261b which are connected consecutively on both sides of the inner insertion space 261a in the Y direction (third direction: width direction), and project farther on the rear side in the X direction (first direction: front and rear direction) than the inner insertion space 261a. In this way, in the present embodiment, a length W2 of the outer insertion spaces 261b in the X direction (first direction: front and rear direction) of the first retainer insertion space 261 is longer than a length W1 of the inner insertion space 261a in the X direction (first direction: front and rear direction).

When the retainer 3 is inserted into the first retainer insertion space 261, a base portion 4 of the retainer 3 is inserted into the inner insertion space 261a, and a pair of side wall portions 5 are inserted into the outer insertion spaces 261b. When the retainer 3 is inserted into the first retainer insertion space 261, ends of the retainer 3 in the Y direction (third direction: width direction) are interposed between one side wall of the side walls 23, and the partition wall 24 of the housing 2.

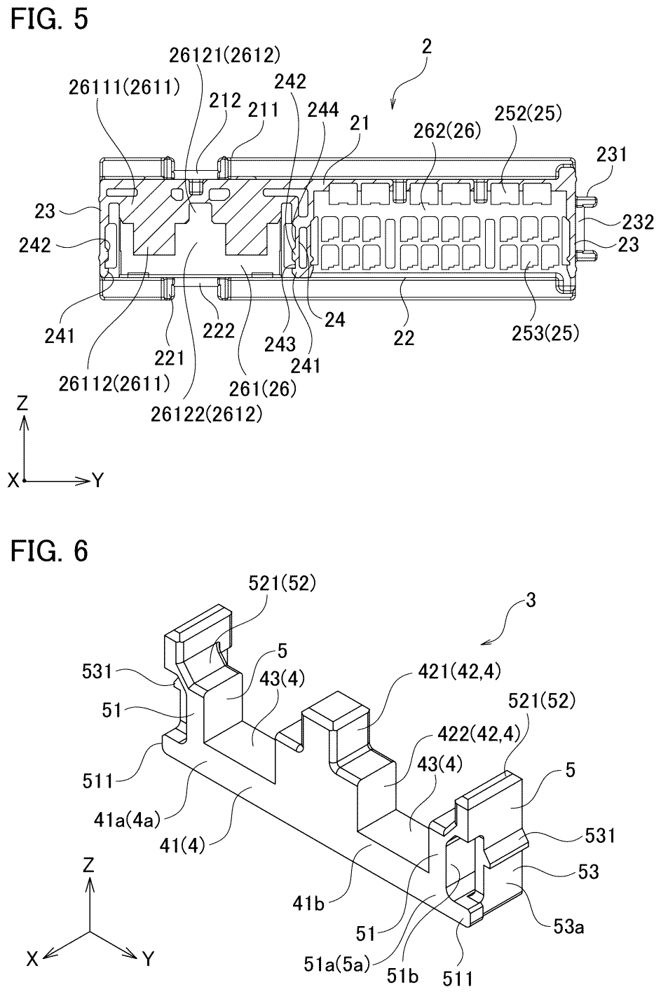

Further, in the present embodiment, as illustrated in FIG. 5, wall portions 2611 and a concave portion 2612 are formed inside the first retainer insertion space 261. Specifically, a pair of wall portions 2611 are formed so as to be separated from each other in the Y direction (third direction: width direction). The concave portion 2612 is formed between the pair of wall portions 2611. In the present embodiment, each of the pair of wall portions 2611 includes an upper wall portion 26111 which is wider in the Y direction (third direction: width direction), and a lower wall portion 26112 which is connected consecutively to a lower end of the upper wall portion 26111 and has a smaller width than the upper wall portion 26111 in the Y direction (third direction: width direction). Further, the concave portion 2612 includes an upper concave portion 26121 which is narrower in the Y direction (third direction: width direction), and a lower concave portion 26122 which is connected consecutively to a lower end of the upper concave portion 26121 and has a larger width than the upper concave portion 26121 in the Y direction (third direction: width direction).

The retainer 3, having a shape corresponding to the shape of the first retainer insertion space 261, is inserted into the first retainer insertion space 261.

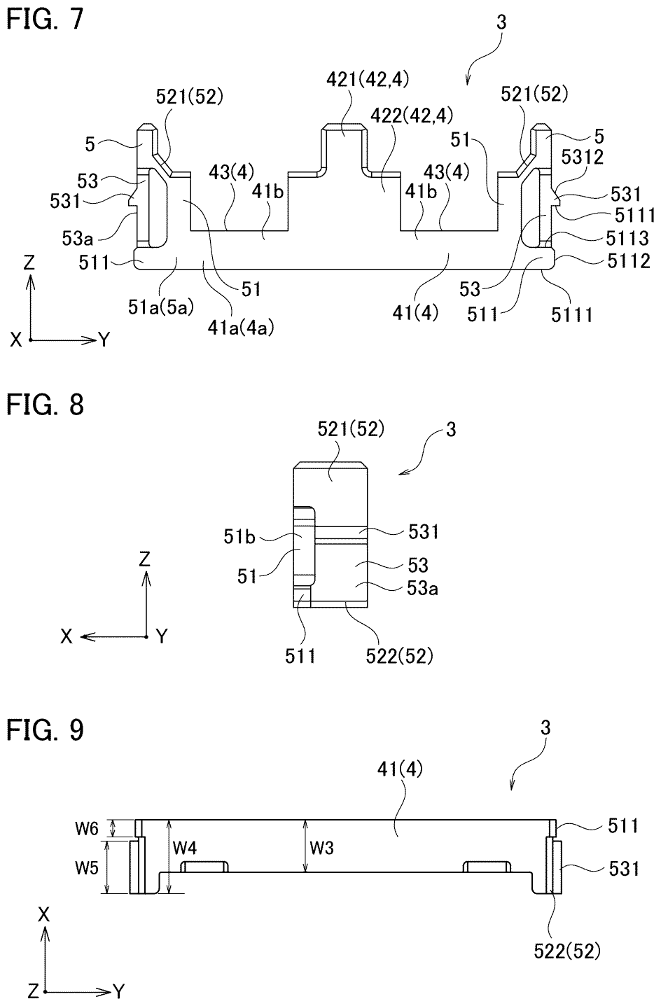

Specifically, as illustrated in FIGS. 6 to 9, the retainer 3 includes the base portion 4, and the pair of side wall portions 5 which are connected consecutively to ends 4a on both sides of the base portion 4 in the Y direction (third direction: width direction).

The pair of side wall portions 5 are formed, such that a length W4 of the pair of side wall portions 5 in the X direction (first direction: front and rear direction) is longer than a length W3 of the base portion 4 in the X direction (first direction: front and rear direction). Specifically, the pair of side wall portions 5 are formed to project on the rear side in the X direction (first direction: front and rear direction) than the base portion 4.

In this way, in the present embodiment, the shapes of the first retainer insertion space 261 and the retainer 3 (contour shapes in plan view) are set to be shapes in which both ends project in the same direction (rear side in front and rear direction). As a result, if the retainer 3 facing in the opposite direction is inserted into the first retainer insertion space 261, the pair of side wall portions 5 interfere with the bottom wall 22 of the housing 2 to prevent the insertion. In this way, in the present embodiment, erroneous insertion of the retainer 3 can be prevented by setting the shapes of the first retainer insertion space 261 and the retainer 3 (contour shapes in plan view) to be shapes in which both ends project in the same direction (rear side in front and rear direction).

Further, in the present embodiment, the retainer 3 is mounted to the housing 2, in a state where the retainer 3 can slide between a temporary locking position at which the retainer 3 is temporarily locked to the housing 2, and a final locking position at which the retainer 3 is finally locked to the housing 2.

Specifically, a locking portion 531 is disposed on each of the pair of side wall portions 5, and a temporary locking projection 241 and a final locking projection 242, located above the temporary locking projection 241, are disposed on each of an inner wall of one of the side walls 23, and an inner wall of the partition wall 24 of the housing 2.

Then, the retainer 3 is inserted into the first retainer insertion space 261 from below, and the locking portion 531 is locked to the temporary locking projection 241. As a result, the retainer 3 is held by the housing 2 in a temporary locking state.

Further, the retainer 3 held by the housing 2 in the temporary locking state is slid upward, and the locking portion 531 is locked to the final locking projection 242. As a result, the retainer 3 is held by the housing 2 in a final locking state.

Due to the above, the retainer 3 is mounted to the housing 2, in the state where the retainer 3 can slide between the temporary locking position at which the retainer 3 is temporarily locked to the housing 2, and the final locking position at which the retainer 3 is finally locked to the housing 2.

In the present embodiment, as illustrated in FIGS. 11 and 13, the temporary locking projection 241 includes a lower inclined surface 2411 inclined inward and upward in the Y direction (third direction: width direction), and a vertical surface 2412 which is connected consecutively to an upper end of the lower inclined surface 2411. Further, the temporary locking projection 241 includes an upper horizontal surface 2413 which is connected consecutively to an upper end of the vertical surface 2412 and extends horizontally.

Further, the locking portion 531 includes a lower horizontal surface 5311 extending outward in the Y direction (third direction: width direction), and an upper inclined surface 5312 inclined inward and upward in the Y direction (third direction: width direction). In this way, in the present embodiment, the locking portion 531 is formed on each of the side wall portions 5, such that the locking portion 531 projects in the Y direction (third direction: width direction), while facing the housing 2 in the Y direction (third direction: width direction).

When the retainer 3 is inserted into the first retainer insertion space 261 from below, the locking portion 531 passes over the temporary locking projection 241 and moves to an upper side of the temporary locking projection 241, and the lower horizontal surface 5311 is locked to the upper horizontal surface 2413. In this way, the retainer 3 is held by the housing 2 (mounted in temporary locking state), in a state where the retainer 3 is prevented from coming off of the housing 2. At this time, the locking portion 531 is accommodated in a temporary locking recess 243 formed between the temporary locking projection 241 and the final locking projection 242.

In the present embodiment, the temporary locking recess 243 includes a vertical surface 2431 connected consecutively to the upper horizontal surface 2413, and the final locking projection 242 is formed at an upper end of the vertical surface 2431.

The final locking projection 242 includes a lower inclined surface 2421 which is connected consecutively to the upper end of the vertical surface 2431 and inclined inward and upward in the Y direction (third direction: width direction), and a vertical surface 2422 which is connected consecutively to an upper end of the lower inclined surface 2421. Further, the final locking projection 242 includes an upper inclined surface 2423 which is connected consecutively to an upper end of the vertical surface 2422 and inclined outward and upward in the Y direction (third direction: width direction).

A final locking recess 244 having a vertical surface 2441 is formed at an upper portion of the final locking projection 242.

Therefore, in the present embodiment, when the retainer 3 held by the housing 2 in the temporary locking state is slid upward, the locking portion 531 passes over the final locking projection 242 and moves to an upper side of the final locking projection 242, and the lower horizontal surface 5311 is locked to the upper inclined surface 2423. Due to the above, the retainer 3 is held by the housing 2 in the final locking state. At this time, the locking portion 531 is accommodated in the final locking recess 244 formed above the final locking projection 242.

In the present embodiment, the retainer 3 is held by the housing 2 in the final locking state by locking the lower horizontal surface 5311 of the locking portion 531 to the upper inclined surface 2423 of the final locking projection 242. Therefore, the retainer 3 held by the housing 2 in the final locking state can be relatively easily slid to the temporary locking position.

Meanwhile, when the retainer 3 is held by the housing 2 in the temporary locking state, the lower horizontal surface 5311 of the locking portion 531 is locked to the upper horizontal surface 2413 of the temporary locking projection 241. Therefore, in the present embodiment, it is not easy for the retainer 3 held by the housing 2 in the temporary locking state to come off of the housing 2. Due to the above, the housing 2 and the retainer 3 can be transferred, while the retainer 3 is held by the housing 2 in the temporary locking state.

In addition, in the present embodiment, when the retainer 3 is located at the temporary locking position, the base portion 4 is configured such that the terminal fitting 6 can be inserted into and removed from the cavity 25. When the retainer 3 is located at the final locking position, the base portion 4 is configured to be engaged with the terminal fitting 6 accommodated in the cavity 25, and regulate the separation of the terminal fitting 6 from the cavity 25.

Specifically, the base portion 4 includes a lower wall portion 41 which is connected consecutively to ends 5a on a lower side of the pair of side wall portions 5, and an intermediate wall 42 which is connected consecutively to a center part of the lower wall portion 41 in the Y direction (third direction: width direction) to project upward.

In this way, in the present embodiment, the base portion 4 includes the lower wall portion 41, and the pair of side wall portions 5 are connected consecutively to ends 41a on both sides of the lower wall portion 41 in the Y direction (third direction: width direction).

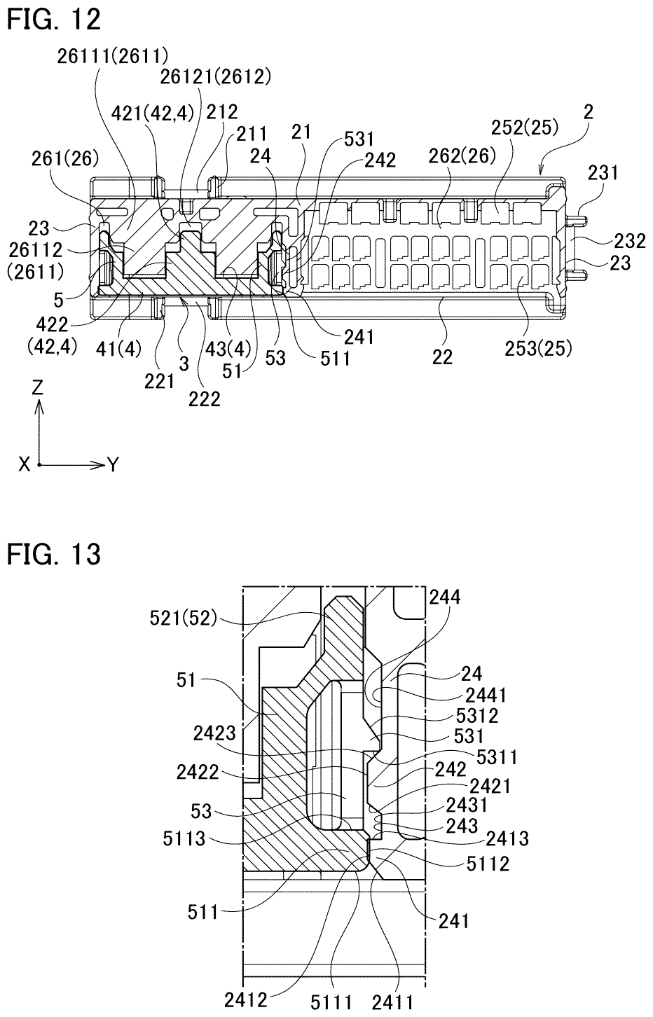

Further, the intermediate wall 42 has a shape corresponding to the shape of the concave portion 2612 of the first retainer insertion space 261, and when the retainer 3 is in the final locking state, the intermediate wall 42 is inserted into the concave portion 2612 (see FIG. 12). That is, the intermediate wall 42 includes an upper wall portion 421 narrower in the Y direction (third direction: width direction), and a lower wall portion 422 which is connected consecutively to a lower end of the upper wall portion 421 and has a larger width than the upper wall portion 421 in the Y direction (third direction: width direction). When the retainer 3 is in the final locking state, the upper wall portion 421 is inserted into the upper concave portion 26121, and the lower wall portion 422 is inserted into the lower concave portion 26122.

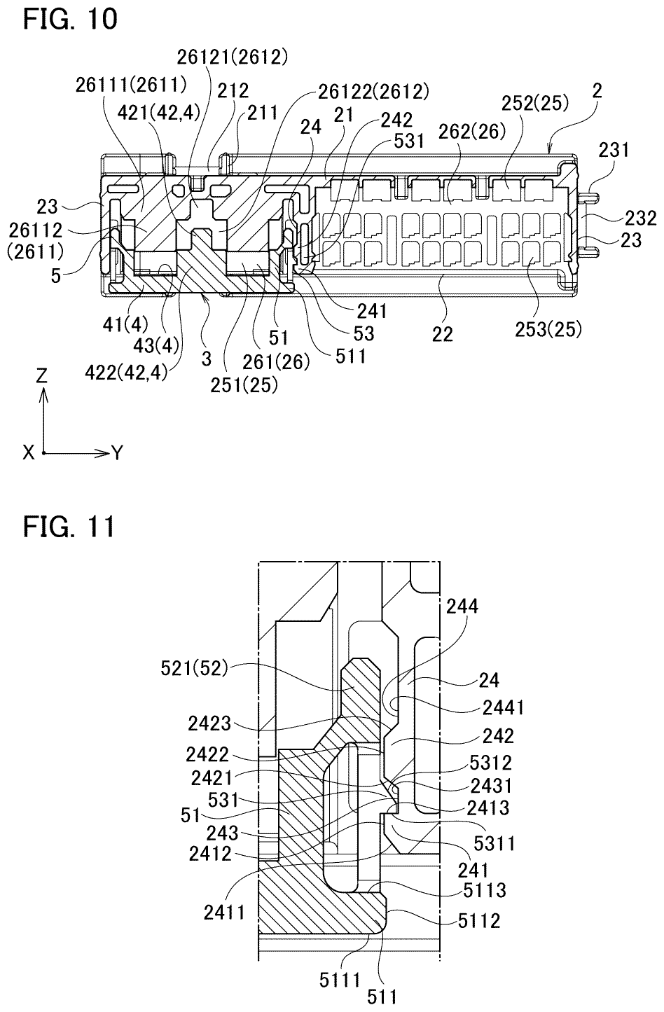

Further, in the present embodiment, a pair of cavity portions 43 are formed between the side wall portions 5 and the intermediate wall 42, and when the retainer 3 is in the temporary locking state, the cavity portions 43 communicate with the first cavity 251 (see FIG. 10). When the retainer 3 is in the final locking state, the cavity portions 43 move upward and are inserted into the wall portions 2611 of the first retainer insertion space 261. At this time, an upper end of the lower wall portion 41 is engaged with the engagement recess 61b in the first terminal fitting 6A, and the movement of the first terminal fitting 6A in the X direction (first direction: front and rear direction) is also regulated by the upper end of the lower wall portion 41.

Therefore, in the present embodiment, the upper end of the lower wall portion 41 serves as the terminal engaging portion 41b of the retainer 3.

Further, in the present embodiment, backlash filling portions 511 are formed on the side wall portions 5 of the retainer 3. When the retainer 3 is in the final locking state, the backlash filling portions 511 abut on the housing 2, and this can suppress backlash of the retainer 3 in the final locking state.

In the present embodiment, each backlash filling portion 511 has a lower surface 5111 and an upper surface 5113 which are approximately horizontal and extend in the Y direction (third direction: width direction), and an approximately vertical side surface 5112 for consecutively connecting the lower surface 5111 and the upper surface 5113. In this way, the backlash filling portions 511 are formed on the side wall portions 5 so as to project outward in the Y direction (third direction). When the retainer 3 is in the final locking state, the side surface 5112 of each backlash filling portion 511 is in surface contact with the vertical surface 2412 of the temporary locking projection 241.

In order for the locking portion 531 to pass over the final locking projection 242, when the retainer 3 is slid from the temporary locking position to the final locking position as in the present embodiment, it is preferable that the side wall portions 5 elastically deform in the Y direction (third direction: width direction). Due to the above, it becomes easy for the locking portion 531 to pass over the final locking projection 242, and it is possible to enhance the sliding operability of the retainer 3.

However, when backlash of the retainer 3 in the final locking state can be suppressed by abutting the backlash filling portions 511 on the housing 2 as in the present embodiment, the side wall portions 5 of the retainer 3 may be bent due to the backlash filling. Specifically, when the retainer 3 is slid to the final locking position, the retainer 3 is compressed in the Y direction (third direction: width direction) by the housing 2, and there is a risk that the side wall portions 5 may be bent due to the compression force. Then, when the side wall portions 5 are bent, the overlap allowance of the locking between the housing 2 and the retainer 3 decreases, and the holding force between the housing 2 and the retainer 3 in the final locking state may deteriorate.

Therefore, in the present embodiment, the holding force between the retainer 3 and the housing 2 can be more reliably ensured, while suppressing backlash of the retainer 3 in the final locking state.

Specifically, the locking portion 531 is formed such that at least a part of the locking portion 531 is located at a part of the side wall portion 5, projecting from the base portion 4 in the X direction (first direction). When the retainer 3 is viewed in the Y direction (third direction), each backlash filling portion 511 is formed at a position spaced apart from the locking portion 531 in the X direction (first direction).

That is, the locking portion 531 is formed on the side wall portion 5 such that at least a part of the locking portion 531 is present at a part of the side wall portion 5 which is wider than the base portion 4, the part projecting from the base portion 4. Then, each backlash filling portion 511 is formed at a position spaced apart from the locking portion 531 on the side wall portion 5 in the X direction (first direction).

In this way, a part where the locking portion 531 is formed outside the side wall portion 5 in the Y direction (third direction), and a part where each backlash filling portion 511 is formed are completely spaced apart from each other in the X direction (first direction).

In this way, even if the retainer 3 is compressed by the housing 2 in the Y direction, when the retainer 3 is slid to the final locking position, it is possible to substantially prevent the compression force applied to the retainer 3 from being transmitted to a part of the side wall portion 5 where the locking portion 531 is formed. That is, even if the retainer 3 is compressed by the housing 2 in the Y direction (third direction), it is possible to prevent the compression force applied to the retainer 3 from affecting the part of the side wall portion 5 where the locking portion 531 is formed.

In this way, in the present embodiment, it is possible to substantially prevent the bending deformation of the part of the side wall portion 5 where the locking portion 531 is formed, by the compression force applied to the retainer 3, when the retainer 3 is compressed by the housing 2. By substantially preventing the bending deformation of the part of the side wall portion 5 where the locking portion 531 is formed, it is possible to prevent a reduction in the overlap allowance (contact area) of the locking portion 531 with the housing 2. Due to the above, even when the backlash filling portion 511 is abutted on the housing 2 in the final locking state, to suppress backlash of the retainer 3 in the final locking state, it is possible to substantially prevent a reduction in the holding force between the retainer 3 and the housing 2.

In the present embodiment, as described above, the locking portion 531 is formed on the side wall portion 5 such that at least a part of the locking portion 531 is present at a part of the side wall portion 5 which is wider than the base portion 4 in the X direction (first direction), the part projecting from the base portion 4.

Due to the above, it is possible to suppress the reduction in a length W5 in the X direction (first direction) of the locking portion 531. The locking portion 531 is formed at a position at which the locking portion 531 is affected as little as possible by the compression force generated in the retainer 3, the compression force being caused by abutment of the backlash filling portions 511 of the side wall portions 5 on the housing 2.

In the present embodiment, the length W5 of the locking portion 531 in the X direction (first direction) is slightly longer than the length W3 of the base portion 4 in the X direction (first direction: front and rear direction). In addition, the sum of the length W5 of the locking portion 531 in the X direction (first direction) and a length W6 of the backlash filling portion 511 in the X direction (first direction), is approximately equal to the length W4 of the side wall portion 5 in the X direction (first direction: front and rear direction).

In this way, the locking portion 531 can be formed at a position at which the locking portion 531 is affected as little as possible by the compression force generated in the retainer 3 by abutment of the backlash filling portions 511 of the side wall portions 5 on the housing 2, without reducing the length of the locking portion 531 in the X direction (first direction).

This allows suppression of the reduction in the overlap allowance (contact area) due to the compression force generated in the retainer 3 as much as possible, while relatively increasing the overlap allowance (contact area) when the locking portion 531 is locked to the housing 2 in the final locking state.

Therefore, when the connector 1 shown in the above embodiment is used, it is possible to more reliably ensure the holding force between the retainer 3 and the housing 2, while suppressing backlash of the retainer 3 in the final locking state.

Further, in the present embodiment, the backlash filling portions 511 are formed at the ends 5a on one side (lower side) in the Z direction (second direction: up and down direction) of the side wall portions 5.

In this way, when the retainer 3 is held by the housing 2 at the temporary locking position, the backlash filling portion 511 does not abut on the housing 2, and when the retainer 3 is held by the housing 2 at the final locking position, the backlash filling portion 511 abuts on the housing 2. Due to this configuration, the compression force applied to the retainer 3, which is caused by abutment of the backlash filling portion 511 on the housing 2, is prevented from being generated at the majority of positions between the temporary locking position and the final locking position. As a result, it is possible to further enhance the operability of the retainer 3, when the retainer 3 is slid from the temporary locking position to the final locking position.

Further, if the compression force is prevented from being generated in the retainer 3 at the temporary locking position, the deformation of the retainer 3 in the temporary locking state is suppressed, and the reduction in the holding force between the retainer 3 and the housing 2 can be prevented. Due to the above, when the housing 2 holding the retainer 3 in the temporary locking state is carried, the retainer 3 can be more reliably prevented from coming off of the housing 2.

Further, in the present embodiment, when the retainer 3 is viewed in the Y direction (third direction: width direction), the backlash filling portion 511 overlaps the base portion 4. Specifically, when the retainer 3 is viewed in the Y direction (third direction: width direction), the entirety of the backlash filling portion 511 overlaps the lower wall portion 41.

In this way, the base portion 4 (lower wall portion 41) can receive the compression force generated in the retainer 3, which is caused by abutment of the backlash filling portion 511 on the housing 2, when the retainer 3 is slid to the final locking position. Due to the above, it is possible to more reliably suppress the deformation of the side wall portions 5 due to the compression force generated in the retainer 3, and more reliably ensure the holding force between the retainer 3 and the housing 2 in the final locking state.

Further, in the present embodiment, each side wall portion 5 includes a side wall body 51 which is connected consecutively to the end 4a of the base portion 4 in the Y direction (third direction: width direction), and a flexible arm 53 which is connected consecutively to the side wall body 51 and which can be bent and deformed in the Y direction (third direction: width direction).

Specifically, the flexible arm 53 is connected consecutively to the side wall body 51 through a coupling wall 52. In the present embodiment, an upper end of the flexible arm 53 is connected consecutively to an upper end of the side wall body 51 through an upper coupling wall 521, and a lower end of the flexible arm 53 is connected consecutively to a lower end (end 51a) of the side wall body 51 through a lower coupling wall 522.

In this way, the flexible arm 53 is held by the side wall body 51 in a double-support state, and the flexible arm 53 can be bent and deformed independently.

At this time, when the retainer 3 is viewed in the Y direction, the flexible arm 53 is connected consecutively to the side wall body 51, in a state where at least a part of the side wall body 51 is exposed, while at least a part of the flexible arm 53 projects on the rear side of the base portion 4. That is, as illustrated in FIG. 8, when the retainer 3 is viewed in the Y direction, a part of an outer surface 51b of the side wall body 51 is exposed without being covered by the flexible arm 53.

The locking portion 531 is formed on the flexible arm 53 which can be bent and deformed. In the present embodiment, the locking portion 531 is formed on an arm surface 53a of the flexible arm 53, such that the locking portion 531 projects outward in the Y direction (third direction: width direction). Due to the above, it is possible to more easily perform an operation of locking the locking portion 531 to the housing 2, or an operation of releasing the locking between the locking portion 531 and the housing 2.

Further, the backlash filling portion 511 is formed at a part of the side wall body 51 exposed from the flexible arm 53.

In this way, in the present embodiment, the side wall body 51 is disposed separately from the flexible arm 53 on which the locking portion 531 is formed, and the backlash filling portion 511 is formed at the side wall body 51. In this way, it is possible to enhance the rigidity of the side wall body 51, while ensuring the flexibility of the flexible arm 53. By enhancing the rigidity of the side wall body 51, it is possible to more reliably prevent the deformation of the side wall body 51, when the side wall body 51 receives the compression force generated in the retainer 3, which is caused by abutment of the backlash filling portions 511 on the housing 2. Due to the above, it is possible to prevent the displacement of the flexible arm 53 connected consecutively to the side wall body 51, and the flexible arm 53 is not substantially affected by the compression force caused by bringing the backlash filling portions 511 into contact with the housing 2. In other words, it is possible to more reliably prevent the flexible arm 53 from bending and deforming inward in the Y direction (third direction: width direction), and the overlap allowance (contact area) of the locking portion 531 with the housing 2 decreases. As a result, it is possible to more reliably ensure the holding force between the retainer 3 and the housing 2 in the final locking state.

Therefore, the holding force between the retainer 3 and the housing 2 in the final locking state can be more reliably ensured, while preventing the deterioration in the operability of the retainer 3, when the locking portion 531 is locked to the housing 2, or the locking between the locking portion 531 and the housing 2 is released.

### [Action/Effect]

In the following, a description will be given regarding the characteristic configuration of the connector shown in the above embodiment, and the effects obtained by them.

The connector 1 shown in the above embodiment includes the housing 2 formed such that cavities 25 in which the terminal fittings 6 are accommodated extend in the X direction (first direction: front and rear direction). Further, the connector 1 includes the retainer 3 inserted into the housing 2 from one side (lower side) in the Z direction (second direction: up and down direction) crossing the X direction (first direction). The retainer 3 is mounted to the housing 2, in a state where the retainer 3 can slide between a temporary locking position at which the retainer 3 is temporarily locked to the housing 2, and a final locking position at which the retainer 3 is finally locked to the housing 2.

Further, the retainer 3 includes the base portion 4. When the retainer 3 is located at the temporary locking position, the base portion 4 is configured such that the terminal fitting 6 can be inserted into and removed from the cavity 25. When the retainer 3 is located at the final locking position, the base portion 4 is configured to be engaged with the terminal fitting 6 accommodated in the cavity 25, and regulate the separation of the terminal fitting 6 from the cavity 25. Further, the retainer 3 includes the side wall portions 5 connected consecutively to the ends 4a of the base portion 4 in the Y direction (third direction: width direction) crossing the X direction (first direction) and the Z direction (second direction).

The length W4 of the side wall portions 5 in the X direction (first direction) is longer than the length W3 of the base portion 4 in the X direction (first direction).

The side wall portion 5 has the locking portion 531 which faces the housing 2 in the Y direction (third direction) and which is locked to the housing 2, when the retainer 3 is located at the final locking position. Further, the side wall portion 5 has the backlash filling portion 511 which projects outward in the Y direction (third direction) and abuts on the housing 2, when the retainer 3 is located at the final locking position.

Further, the locking portion 531 is formed such that at least a part of the locking portion 531 is located at a part of the side wall portion 5, projecting from the base portion 4 in the X direction (first direction). When the retainer 3 is viewed in the Y direction (third direction), the backlash filling portion 511 is formed at a position spaced apart from the locking portion 531 in the X direction (first direction).

In this way, the retainer 3 of the connector 1 shown in the above embodiment has the side wall portion 5, which is wider than the base portion 4 in the X direction (first direction) in plan view. The locking portion 531 is formed on the side wall portion 5, such that at least a part of the locking portion 531 is present at a part of the side wall portion 5, which is wider than the base portion 4, the part projecting from the base portion 4. Further, the backlash filling portion 511 is formed at a position spaced apart from the locking portion 531 on the side wall portion 5 in the X direction (first direction).

That is, in the connector 1 shown in the above embodiment, a part where the locking portion 531 is formed outside the side wall portion 5 in the Y direction (third direction), and a part where the backlash filling portion 511 is formed, are spaced apart from each other in the X direction (first direction).

In this way, even if the retainer 3 is compressed by the housing 2 in the Y direction, when the retainer 3 is slid to the final locking position, it is possible to substantially prevent the compression force applied to the retainer 3 from being transmitted to a part of the side wall portion 5 where the locking portion 531 is formed. That is, even if the retainer 3 is compressed by the housing 2 in the Y direction (third direction), it is possible to prevent the compression force applied to the retainer 3 from affecting the part of the side wall portion 5 where the locking portion 531 is formed. In this way, it is possible to substantially prevent bending deformation of the part of the side wall portion 5 where the locking portion 531 is formed, by the compression force applied to the retainer 3, when the retainer 3 is compressed by the housing 2. By substantially preventing the bending deformation of the part of the side wall portion 5 where the locking portion 531 is formed, it is possible to prevent a reduction in the overlap allowance (contact area) of the locking portion 531 with the housing 2. As a result, even when the backlash filling portion 511 is abutted on the housing 2 in the final locking state, to suppress backlash of the retainer 3 in the final locking state, it is possible to substantially prevent the reduction in the holding force between the retainer 3 and the housing 2.

Further, in the connector 1 shown in the above embodiment, as described above, the locking portion 531 is formed on the side wall portion 5, such that at least a part of the locking portion 531 is present at a part of the side wall portion 5 which is wider than the base portion 4 in the X direction (first direction), the part projecting from the base portion 4.

Due to the above, it is possible to suppress the reduction in the length in the X direction (first direction) of the locking portion 531. The locking portion 531 is formed at a position at which the locking portion 531 is affected as little as possible by the compression force generated in the retainer 3, the compression force being caused by abutment of the backlash filling portion 511 of the side wall portion 5 on the housing 2. That is, the locking portion 531 can be formed at a position at which the locking portion 531 is affected as little as possible by the compression force generated in the retainer 3 by abutment of the backlash filling portion 511 of the side wall portion 5 on the housing 2, without reducing the length of the locking portion 531 in the X direction (first direction). If the side wall portion 5 has the same width as the base portion 4, and the locking portion 531 and the backlash filling portion 511 are formed at positions spaced apart from each other, it is not possible to avoid reducing the length of the locking portion 531 in the X direction (first direction), for example. Meanwhile, if the side wall portion 5 is wider than the base portion 4 in the X direction (first direction) as in the connector 1 shown in the above embodiment, it is possible to increase the length of the locking portion 531 in the X direction (first direction), more than when the side wall portion 5 has the same width as the base portion 4. As a result, it is possible to increase the contact area of the locking portion 531 with the housing 2.

In this way, when the connector 1 shown in the above embodiment is used, it is possible to substantially suppress the reduction in the overlap allowance (contact area) due to the compression force generated in the retainer 3, while relatively increasing the overlap allowance (contact area), when the locking portion 531 is locked to the housing 2 in the final locking state.

Therefore, when the connector 1 shown in the above embodiment is used, it is possible to more reliably ensure the holding force between the retainer 3 and the housing 2, while suppressing backlash of the retainer 3 in the final locking state.

Further, the backlash filling portion 511 may be formed at the end 5a on one side (lower side) in the Z direction (second direction: up and down direction) of the side wall portion 5.

In this way, the connector 1 can be achieved in which when the retainer 3 is held by the housing 2 at the temporary locking position, the backlash filling portion 511 does not abut on the housing 2, and when the retainer 3 is held by the housing 2 at the final locking position, the backlash filling portion 511 abuts on the housing 2. Due to this configuration, the compression force applied to the retainer 3, which is caused by abutment of the backlash filling portion 511 on the housing 2 can be prevented from being generated at the majority of positions from the temporary locking position to the final locking position. As a result, it is possible to further enhance the operability of the retainer 3, when the retainer 3 is slid from the temporary locking position to the final locking position.

Further, if the compression force is prevented from being generated in the retainer 3 at the temporary locking position, the deformation of the retainer 3 in the temporary locking state is suppressed, and the reduction in the holding force between the retainer 3 and the housing 2 can be prevented. Due to the above, when the housing 2 holding the retainer 3 in the temporary locking state is carried, the retainer 3 can be more reliably prevented from coming off of the housing 2.

Further, when the retainer 3 is viewed in the Y direction (third direction: width direction), the backlash filling portion 511 may be formed to overlap the base portion 4.

In this way, the base portion 4 can receive the compression force generated in the retainer 3, which is caused by abutment of the backlash filling portion 511 on the housing 2, when the retainer 3 is slid to the final locking position. As a result, it is possible to more reliably suppress the deformation of the side wall portion 5 due to the compression force generated in the retainer 3, and more reliably ensure the holding force between the retainer 3 and the housing 2 in the final locking state.

Further, the side wall portion 5 may include the side wall body 51 which is connected consecutively to the end 4a of the base portion 4 in the Y direction (third direction: width direction), and the flexible arm 53 which is connected consecutively to the side wall body 51 and which can be bent and deformed in the Y direction (third direction: width direction).

When the retainer 3 is viewed in the Y direction (third direction), the side wall body 51 and the flexible arm 53 may be formed, such that at least a part of the side wall body 51 is exposed, and at least a part of the flexible arm 53 projects in the X direction (first direction) from the base portion 4.

The locking portion 531 may be formed on the flexible arm 53, and the backlash filling portion 511 may be formed at a part exposed from the flexible arm 53 at the side wall body 51.

In this way, if the locking portion 531 is formed on the flexible arm 53, it is possible to more easily perform an operation of locking the locking portion 531 to the housing 2, or an operation of releasing the locking between the locking portion 531 and the housing 2.

Further, if the side wall body 51 is disposed separately from the flexible arm 53 on which the locking portion 531 is formed, and the backlash filling portion 511 is formed at the side wall body 51, it is possible to enhance the rigidity of the side wall body 51, while ensuring the flexibility of the flexible arm 53. If the rigidity of the side wall body 51 is enhanced, it is possible to more reliably prevent the deformation of the side wall body 51, when the side wall body 51 receives the compression force generated in the retainer 3, which is caused by abutment of the backlash filling portion 511 on the housing 2. As a result, it is possible to prevent the displacement of the flexible arm 53 connected consecutively to the side wall body 51, and the flexible arm 53 is not substantially affected by the compression force caused by bringing the backlash filling portion 511 into contact with the housing 2. In this way, it is possible to more reliably prevent the flexible arm 53 from bending and deforming inward in the Y direction (third direction: width direction), and the overlap allowance (contact area) of the locking portion 531 with the housing 2 decreases. As a result, it is possible to more reliably ensure the holding force between the retainer 3 and the housing 2 in the final locking state.

Therefore, the holding force between the retainer 3 and the housing 2 in the final locking state can be more reliably ensured, while preventing the deterioration in the operability of the retainer 3, when the locking portion 531 is locked to the housing 2, or the locking between the locking portion 531 and the housing 2 is released.

### [Others]

Although the present embodiment has been described above, the present embodiment is not limited to the above description, and various modifications can be made within the scope of the gist of the present embodiment.

The above embodiment shows an example in which the locking portion 531 formed on the side wall portion 5 (flexible arm 53) serves as both a final locking portion and a temporary locking portion, but it is also possible to dispose a temporary locking portion separately from the locking portion 531 serving as a final locking portion, for example. In this case, it is preferable to dispose the temporary locking portion on the side wall portion 5 (flexible arm 53).

In addition, the specifications (shape, size, layout, and the like) of the housing, the terminal fitting, and other details can be appropriately changed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a housing formed such that a cavity in which a terminal fitting is accommodated extends in a first direction; and
a retainer that is inserted into the housing from one side in a second direction crossing the first direction, and that is mounted to the housing, in a state where the retainer can slide between a temporary locking position at which the retainer is temporarily locked to the housing, and a final locking position at which the retainer is finally locked to the housing, wherein
the retainer includes:
a base portion that allows the terminal fitting to be inserted into and removed from the cavity, when the retainer is located at the temporary locking position, and that is engaged with the terminal fitting accommodated in the cavity and regulates separation of the terminal fitting from the cavity, when the retainer is located at the final locking position; and
a side wall portion connected consecutively to an end of the base portion in a third direction crossing the first direction and the second direction,
a length of the side wall portion in the first direction is longer than a length of the base portion in the first direction,
the side wall portion includes:
a locking portion that faces the housing in the third direction and that is locked to the housing, when the retainer is located at the final locking position; and
a backlash filling portion that projects outward in the third direction and abuts on the housing, when the retainer is located at the final locking position,
the locking portion is formed such that at least a part of the locking portion is located at a part of the side wall portion projecting from the base portion in the first direction, and
when the retainer is viewed in the third direction, the backlash filling portion is formed at a position spaced apart from the locking portion in the first direction.

2. The connector according to claim 1, wherein
the backlash filling portion is formed at an end on the one side in the second direction of the side wall portion.

3. The connector according to claim 1, wherein
when the retainer is viewed in the third direction, the backlash filling portion is formed to overlap the base portion.

4. The connector according to claim 1, wherein
the side wall portion includes:
a side wall body that is connected consecutively to the end of the base portion in the third direction; and
a flexible arm that is connected consecutively to the side wall body and that can be bent and deformed in the third direction,
when the retainer is viewed in the third direction, the side wall body and the flexible arm are formed such that at least a part of the side wall body is exposed, and at least a part of the flexible arm projects in the first direction from the base portion, and
the locking portion is formed on the flexible arm, and the backlash filling portion is formed at a part of the side wall body exposed from the flexible arm.
